(19) United States
(12) Patent Application Publication
(10) Pub. No.: US 2026/0228441 A1
(43) Pub. Date: Aug. 6, 2026

(54) CROSS-DEVICE LARGE LANGUAGE MODEL RESPONSE GENERATION

(71) Applicant: Lenovo (United States) Inc., Morrisville, NC (US)

(72) Inventors: John W. Nicholson, Cary, NC (US); Howard Locker, Cary, NC (US); Daryl C. Cromer, Raleigh, NC (US)

(21) Appl. No.: 19/042,714

(22) Filed: Jan. 31, 2025

(51) Int. Cl. G06F 40/35; G06N 5/02

(52) U.S. Cl. CPC G06F 40/35; G06N 5/02

(57) ABSTRACT

One embodiment provides a method, including: receiving, at an information handling device, a prompt from a user; sharing, utilizing a response generation system, the prompt across a plurality of devices in communication with the information handling device; determining, from at least one of the plurality of devices and utilizing an artificial intelligence model of the at least one of the plurality of devices, a response to the prompt; and providing, at the information handling device, the response to the user. Other aspects are claimed and described.

### BACKGROUND

Modern information handling devices contain processing strength far greater than what was available even a few years ago. A device's ability to accept, manipulate, and output a response, value, and/or the like, permits the use of a device in far more situations. Additionally, this increase in processing power permits the implementation and utilization of artificial intelligence models at the most common devices (e.g., smartphone, tablet, laptop, etc.), which was previously restricted to devices that included an above-average processing power strength. With this newfound processing ability for even the most common devices, the use of artificial intelligence and machine-learning models permits performing high-functioning actions whenever a user desires.

### BRIEF SUMMARY

In summary, one aspect provides a method, including: receiving, at an information handling device, a prompt from a user; sharing, utilizing a response generation system, the prompt across a plurality of devices in communication with the information handling device; determining, from at least one of the plurality of devices and utilizing an artificial intelligence model of the at least one of the plurality of devices, a response to the prompt; and providing, at the information handling device, the response to the user.

Another aspect provides a system, the system including: a processor; a memory device that stores instructions that, when executed by the processor, causes the system to: receive, at an information handling device, a prompt from a device; share, utilizing a response generation system, the received prompt across a plurality of devices in communication with the information handling device; determine, from at least one of the plurality of devices and utilizing an artificial intelligence model of the at least one of the plurality of devices, a response to the prompt; and provide, at the information handling device, the response to the user.

A further aspect provides a product, the product including: a computer-readable storage device that stores code that, when executed by a processor, causes the product to: receive, at an information handling device, a prompt from a user; share, utilizing a response generation system, the prompt across a plurality of devices in communication with the information handling device; determine, from at least one of the plurality of devices and utilizing an artificial intelligence model of the at least one of the plurality of devices, a response to the prompt; and provide, at the information handling device, the response to the user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for determining a response to a received prompt utilizing an artificial intelligence model and providing a response to a user by use of a response generation system.

FIG. 4. provides an example illustration of a response generation system and the steps taken in order to generate a response to a received prompt by use of a plurality of devices in communication and each associated with an independent large language model and knowledge graph.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Utilization of artificial intelligence models, specifically, large language models (LLMs) require a lot of memory. Due to the size of an artificial intelligence model, multi-gigabyte storage areas are required to house an entire model. Devices accessing and utilizing larger LLMs have the ability produce more accurate answers. However, because the amount of memory required to operate a large language model is associated with an amount of storage available to a device, smaller devices (e.g., a smartphone) with smaller memories will utilize smaller LLMs in comparison to larger devices (e.g., a PC) that can use a larger LLM. Additionally, or alternatively, larger devices that access larger LLMs also require and utilize more bandwidth when accessing stored information. A larger device will consume some power resulting is greater processing power and acting as higher performance devices. Therefore, more accurate answers may be produced by a much larger device. This also results in high costs in energy, and limits devices which could utilize an artificial intelligence model. Additionally, large language models are trained with different capabilities, strengths, and emphases. Specific concentrations of large language models may further limit device access and how devices may be permitted to operate. For example, a large language model on a smartphone may be focused on generating short replies for messaging and email. Even further, a knowledge graph of a device may be used in combination with a large language model, which may be updated based upon use. Thus, a device that is not as commonly used as another device may be limited to specific topics and limits the utilization of large language models based upon this common-use knowledge graph training. If the device is not used, the knowledge graph is not produced; thus, utilizing a large language model at a device that is unfamiliar with a topic may not produce a desired result. Another difference is different devices have different sensors and mobility. Example a smart phone would have a better record of where you have been vs. your PC.

Additionally, and/or alternatively, when producing a personal knowledge base for a user, a variety of devices may utilize different sensors for collecting data, therefore, having an ability collect information about a user that may not be accessible by a separate device. For example, a smartphone, and/or a wearable device, that is with a person throughout a day may track location data, biometric data, and/or the like. A device that is not routinely with a person, for example, a PC, will not have access to such user data and will lack this knowledge when producing a personal knowledge base. In producing a general knowledge base, the data collected and associated with a person, and/or their personal knowledge base, may be shared across devices, which may assist with storage of data at memory devices that can accept more data.

Traditional devices are limited in LLM size due to lack of device memory, memory bandwidth, and processing power. Size limitations reduce accuracy and precision of a large language model since a large language model will be unable to obtain data that is inaccessible due to device size. For example, as mentioned previously, smaller devices that have access to a smaller LLM may lack accuracy when providing a response in comparison to a device that may utilize a larger LLM that has access to a greater amount of information. Additionally, a device that can perform an action and/or generate a response by use of a large language model may exist, but may not be the device that a user is currently interacting with. Therefore, what is needed is a system and method that may utilize large language models of devices that are in communication to produce a response to prompt regardless of the limitations of an information handling device that may receive a prompt. Utilization of cross-device response determination may result in thorough responses generated by a large language model while simultaneously negating the requirement of accessing, housing, and implementing a large language model from a specific device and/or a device in communication with the device currently in use by user.

Accordingly, the described system provides a method for providing a response to a prompt received at a device by use of a response generation system. The system and method may receive a prompt from a user at an information handling device. The prompt may include one or more questions and/or actions that requires a response to be provided back to the user. In the system, receiving a prompt from a user may include, for example, receiving audible input from the user, receiving text input from a user, receiving gesture input from a user, electromyography input from a user, and/or the like. Thus, receipt of the prompt may further include utilizing at least one sensor (e.g., a microphone, image capture device, mechanical input, electromyography sensor, etc.) when receiving the prompt. Additionally, and/or alternatively, receiving the prompt may be received utilizing a variety of input methods, and is not limited to the identified inputs.

After the system has received a prompt from the user at the information handling device, the response generation system present on the information handling device may share the prompt across at least one of a plurality of devices in communication with the information handling device. Each of the plurality of devices in communication with the information handling device may be previously paired with the information handling device of the user. For example, the system may recognize communication between devices based upon recognition of a user profile present on a device. A predetermined relationship between the information handling device of the user receiving the prompt and a plurality of additional devices may provide a response generation system with access to a plurality of artificial intelligence models when attempting to respond to a received prompt.

The response generation system may employ an artificial intelligence model. Additionally, and/or alternatively, each of the plurality of devices in communication with the information handling device may also employ an artificial intelligence model, each comprising a knowledge graph and a large language model. In the system, the response generation system present on the information handling device may be permitted to communicate with the artificial intelligence models present on each of the plurality of devices from the information handling device that received the input. Therefore, when determining a response to a prompt received at an information handling, the response generation system may utilize the artificial intelligence model of each of the plurality of devices in communication with the information handling in combination with the artificial intelligence model present on the information handling device to produce the best response to the received prompt. Then, when it is determined by the response generation system that a suitable response to the prompt can be supplied, the response generation system may provide the response to the user. In the system, providing a response to the user may include performing an action, supplying an answer, supplying instruction, and/or the like.

Such a system and method provide an improvement over traditional response generation techniques that may only utilize an artificial intelligence model present on the information handling device that received the prompt. Rather than relying solely on the information present within a large language model and knowledge graphs associated with a single device, the provided system and method may reference a plurality of artificial intelligence models, including a LLM and knowledge graph, present on each of a plurality of devices in communication with an information handling device containing a response generation system. The cross referencing of responses generated by the combination of artificial models from a plurality of devices that are in communication will produce a more accurate and thorough response because of the system's ability to weigh more aspects associated with the received prompt.

The illustrated example embodiments will be best understood by reference to the figures. The following description is intended only by way of example, and simply illustrates certain example embodiments.

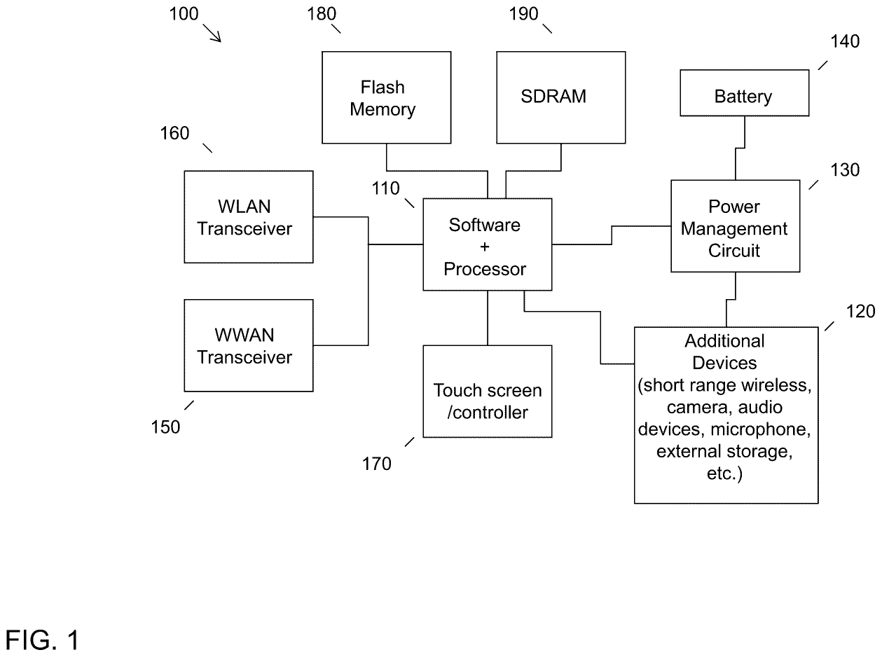

While various other circuits, circuitry or components may be utilized in information handling devices, with regard to personal computer, smart phone and/or tablet circuitry 100, an example illustrated in FIG. 1 includes a system on a chip design found for example in PC, tablet, SP or other mobile computing platforms. Software and processor(s) are combined in a single chip 110. Processors include internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN), and personal area network, transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

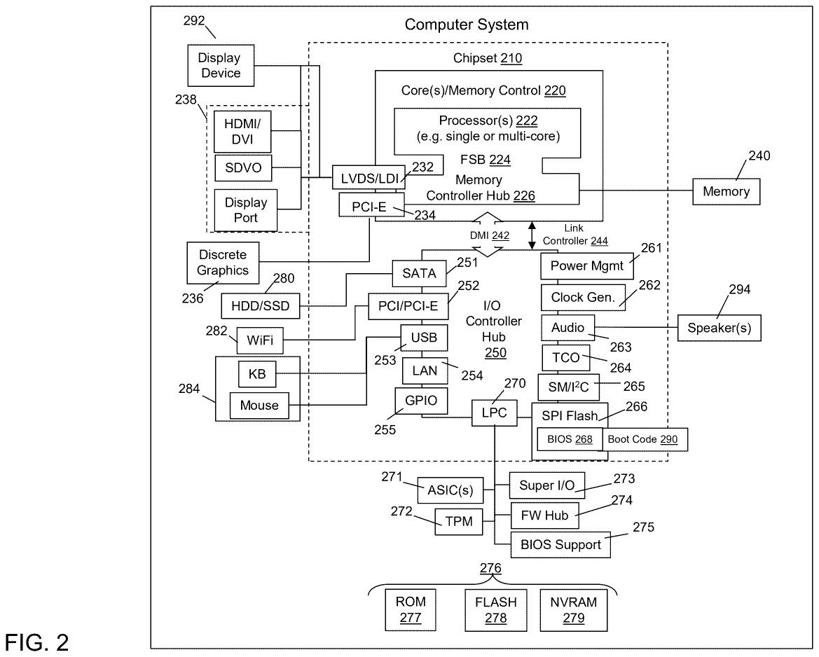

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 include internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may include devices that may be paired with each other, devices that can receive prompts from a user, and/or the like. For example, the circuitry outlined in FIG. 1 may be implemented in a tablet and/or personal computer environment, whereas the circuitry outlined in FIG. 2 may be implemented in a personal computer embodiment.

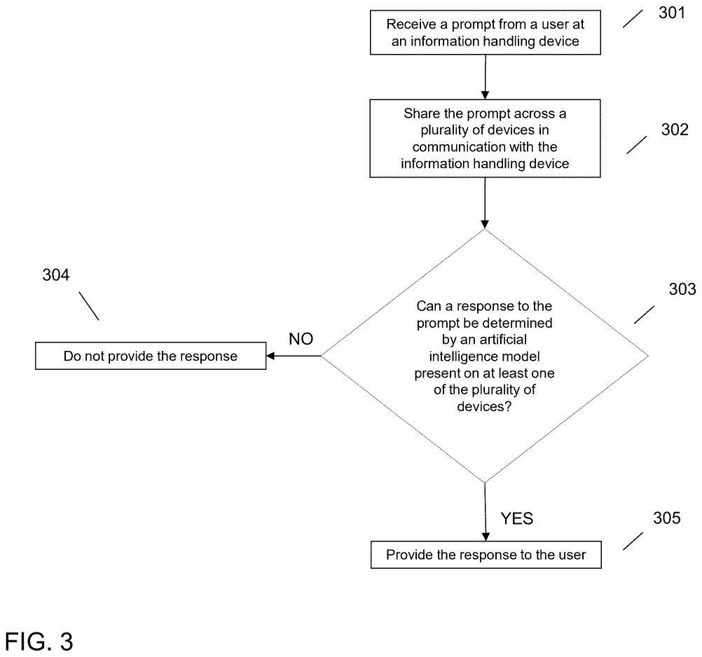

FIG. 3 illustrates an example method for determining a response to a received prompt utilizing an artificial intelligence model and providing a response to a user by use of a response generation system. The method may be implemented on a system which includes a processor, memory device, output devices (e.g., display device, etc.), input devices (e.g., keyboard, touch screen, mouse, microphones, sensors, etc.), and/or other components, for example, those discussed in connection with FIG. 1 and/or FIG. 2. While the system may include known hardware and software components and/or hardware and software components developed in the future, the system itself is specifically programmed to perform the functions as described herein to generate a response to a prompt received at an information handling device in communication with a plurality of devices by use of a response generation system that utilizes artificial intelligence models associated with each of the plurality of devices. Additionally, the response generation system includes modules and features that are unique to the described system.

Activation of the response generation system may be a manual activation of the response generation system and/or an automatic activation of the response generation system. A manual activation of the response generation system may include, for example, selection of the response generation system present within an operating system search bar. The automatic activation of the response generation system may be based upon the detection of a trigger event indicating that the system should be activated.

The response generation system may be made of multiple systems or modules that communicate together to make up the response generation system or may be a single system. The response generation system may be a standalone system, may be accessible through other computing devices, and/or a combination thereof. For example, the response generation system may be a standalone system that can be accessed by a user and/or may be or provide an application that is accessible by a user on another computing device. The response generation system may be accessible using any type of computing device, for example, personal computer, laptop computer, smartphone, tablet, smartwatch, head-mounted display, smart television or other smart appliance, augmented reality device, virtual reality device, and/or the like.

Thus, the response generation system may be a standalone system, may be accessible through other computing devices, and/or a combination thereof. For example, the response generation system may be a standalone system accessed by a user and/or may be provided as an application that is accessible by a user on a computing device. The response generation system may be accessible using any type of computing device, for example, a personal computer, laptop computer, smartphone, tablet, smartwatch, smart television, smart appliance, smart glass device, augmented reality device, virtual reality device, and/or the like. The response generation system may be accessible locally using a computing device where the response generation system is installed and/or may be accessible remotely through another computing device. However, the response generation system may be located and operated on an information handling device to perform the described steps.

The response generation system may utilize one or more artificial intelligence models in receiving a prompt from a user, sharing the prompt across a plurality of devices in communication with the information handling device, determining a response to the prompt, and providing the response to the prompt to the user, and/or the like. Artificial intelligence models may also be used for steps within a step. For example, a model could be utilized in determining a response to the prompt received. As another example, a model could be utilized to share the prompt across a plurality of devices in communication based upon relevant knowledge graph shards, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the response generation system or may be a model that is created from scratch. Since the response generation system is used in conjunction with determining a response to a prompt received at an information handling device, some models that may be utilized by the system are audio analysis models, gesture analysis models, image analysis models, other analysis models, entity identification models, similarity identification models, language models, large language models, filtering models, classification models, and/or the like. The model may be trained using one or more training datasets.

Additionally, as the model or knowledge graph is deployed, it may receive feedback to become more accurate over time. Alternatively, or additionally, the model or knowledge graph may utilize inputs provided to the model or knowledge graph to learn continually, thereby using the inputs to make subsequent predictions or using the inputs within the subsequent predictions. The feedback or inputs may be automatically ingested by the model or knowledge graph as it is deployed. For example, as the model or knowledge graph is used to perform the described method, if a user modifies predictions that were made by the model or knowledge graph, provides feedback regarding a prediction, or otherwise provides some indication that the predictions or selections made by the model or knowledge graph may be incorrect, the model or knowledge graph may ingest this feedback to refine the model.

On the other hand, as the model or knowledge graph makes predictions in connection with performing the described steps, and no changes are made to the resulting prediction, the model or knowledge graph may utilize this as feedback to further refine the model. This may be referred to as reinforcement training where a prediction that was made by the model or knowledge graph is reinforced as the correct prediction. Training the model or knowledge graph may be performed in one of any number of ways including, but not limited to, supervised learning, unsupervised learning, semi-supervised learning, training/validation/testing learning, and/or the like.

The feedback or inputs could be stored within a data store and utilized at a later time to train or retrain the model or knowledge graph. For example, a user could use the feedback to update a training dataset to train or retrain the model or knowledge graph. The feedback or inputs could also be stored within the data store and then be used by the model or knowledge graph for updated training. This may be done, for example, in an unsupervised learning session that allows the model or knowledge graph to learn patterns and information regarding the training dataset without the need for human supervision, thereby providing at least a partially automated technique for the model or knowledge graph to become updated. However, the model or knowledge graph may or may not perform this retraining without a human providing input to the model or knowledge graph to perform the retraining. In other words, retraining of the model or knowledge graph may be based upon how the model or knowledge graph is programmed and whether the model or knowledge graph is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The response generation system may include different components for carrying out different functions of the system, including different steps to be performed. These components may be hardware components or software components. Some hardware components may include sensors (e.g., image capture devices, proximity sensors, microphones, accelerometers, activity trackers, health metric sensors, etc.) that can be used in receiving a prompt from a user, sharing the prompt across a plurality of devices in communication with the information handling device, determining a response to the prompt, and providing the response to the prompt to the user, and/or the like. Additionally, the hardware components can be used to update a knowledge graph, the artificial intelligence model, and/or other learning system. Other input devices may also be utilized, for example, mechanical input modalities (e.g., keyboard, mouse, etc.), touch input devices, gesture input devices, electromyography input devices, audio input devices, image capture devices, and/or the like. Other hardware components may be utilized to provide output from the screen mirroring system.

The response generation system may include one or more profiles to assist in determining a response to a prompt by use of an artificial intelligence model. For example, a profile may include information about preferred determination methods, what different devices may indicate, how to determine a response, and/or the like. The user may manually populate information within the user profile or the information may be populated by the system as the system learns about the user over time. For example, the system may utilize an artificial intelligence model to learn about the user, make correlations between information received from sensors and other inputs and displayed information, identify what different inputs indicate, and/or the like. This information can be populated within the user profile for use by the system during subsequent screen extension determinations. The user profile may also include other information about the user that seems relevant to the system.

At 301, an information handling device of a user may receive a prompt from a user. The information handling device may detect a user is attempting to provide a prompt at the information handling device based upon a recognized input method. A prompt may instruct a system to provide a response to a query, perform an action, and/or the like. In the system, the prompt may be received by a sensor operatively and/or integrally coupled to the information handling device. An input method may be any type of input method that permits the receipt of a prompt at an information handling device. For example, the input method may include an audible input (e.g., voice input), manual input (e.g., a typing input), visual input (e.g., gesture input), and/or the like.

An acceptable input method at the information handling device is supported by a sensor type present at the information handling device. For example, the received prompt from a user may be audibly provided from the user and detected by an audio receiving component (e.g., a microphone) integrally coupled to the information handling device. Additionally, and/or alternatively, for example, the received prompt from a user may be a manual input (e.g., typing input, selection input, etc.) provided by a user at a peripheral device (e.g., keyboard, soft keyboard, mouse, touch screen, etc.) operatively coupled to the information handling device. Additionally, and/or alternatively, for example, the received prompt from a user may be a manual input (e.g., typing input, touch input, etc.) provided by a user at a portion of a graphical user interface (e.g., soft keyboard) integrally coupled to the information handling device. Receipt of a prompt utilizing an audible input and at least one audio receiving device will be the example input discussed throughout. However, these are intended as non-limiting examples. Thus, the receipt of the prompt can be receipt of any type of input supported by a device and the device components, and/or sensors, present at and/or operatively coupled to the device.

After receiving a prompt from a user at an information handling device, the system may share the prompt across a plurality of devices in communication with the information handling device at 302. An information handling device may utilize a response generation system when attempting to share the received prompt with at least one additional device in communication with the information handling device. In other words, the response generation system may accept the prompt and thereafter share the prompt with additional devices that are in operative communication with the information handling device. The information handling device and a plurality of devices in communication device may be paired based upon an established communicative relationship between devices. For example, the information handling device and a plurality of additional devices may be in communication based upon a traditional Internet of Things (IoT) modality, across a network connection, through a wireless communication connection, through a wired communication connection, and/or the like.

With an IoT configuration, each device may be preconfigured to communicate with one another based upon, for example, common ownership of all devices, common application use across devices, recognition of a user profile present on each device in communication, and/or the like. Therefore, when sharing the prompt across a plurality of devices in communication with the information handling device, the response generation system may identify each of a plurality of devices that the information handling device that received the prompt is in communication with, and thereafter, provide the prompt to each of the identified additional devices.

It should be noted that the prompt does not have to be shared with all devices that are in communication with the information handling device. Rather, the prompt could be shared with a subset of the devices in communication with the information handling device, with the subset being as few as one other device and as many as all other devices. When sharing the prompt across a plurality of devices in communication with the information handling device, the device that the prompt is shared with may only include those devices that could process a received prompt. For example, a device with an operating system that may reference a particular storage location may be permitted, whereas a device that cannot reference the storage location may be excluded. As another example, a device that is unable to perform an action associated with the response may be excluded and only devices that can perform the action are included in the sharing.

How many and which devices the prompt is shared with may be set by a user within the user profile, selected by the user at the time of provision of the prompt, learned by the system over time, based upon characteristics of the communication connection between devices (e.g., strength of connection, connection type, etc.), based upon characteristics of the devices (e.g., whether the device has a dedicated artificial intelligence model, a power level of a device, a proximity of a device to another device, availability of certain devices, etc.), a knowledge graph of each device in communication, and/or the like. Example additional devices for receiving the shared prompt include smartphones, laptops, personal computers, tablets, network devices, and/or the like.

The response generation system may determine how a prompt may be shared across a plurality of devices. For example, the prompt received at 301 may be shared in its entirety to each of the plurality devices in communication with the information handling device at 302 and/or only portions of the prompt may be shared. Additionally, in the event that only portions of the prompt are shared, different devices may receive different portions of the prompt and/or some devices may receive the entirety of the prompt. For example, one device may only contain information related to a portion of the prompt. Accordingly, the portion of the prompt provided to that device may only be the portion of the prompt that is applicable to the device. As another example, devices or components may be connected together to operate as a single device entity, with different devices or modules of the device entity responsible for particular data, information, functions, and/or the like. Accordingly, the prompt may be spilt among these different devices within the single device entity. Other techniques or reasons for splitting a prompt are contemplated and possible. Determining how much of the prompt is shared and which devices receive what portion of the prompt may be based upon the device-type of the additional devices receiving the shared prompt and/or the knowledge graph associated with each device. The device-type may identify the capabilities of the device. Identifying a device-type may include identifying components of the device, for example, processing power of the device, external components or systems accessible to the device, memory resources of the device, and/or the like.

For example, a device that is determined to have a processing power greater than a predetermined, and/or required, threshold may receive the entirety of the prompt, while a device that does not have a processing power greater than the predetermined and/or required threshold may only receive a portion of the prompt or none of the prompt. As another example, the response generation system may share the entire prompt with a laptop that is determined to include the processing power required to interpret the whole prompt. Additionally, the response generation system may determine that a device in communication with the information handling device may lack components necessary to process an entire prompt, but may include components that may process a simpler, shorter, abbreviated, etc., form of a prompt. For example, the response generation system may share condensed version of a prompt to this device, for example, a device containing a single microcontroller, which may have success processing a prompt that is provided in simpler terms. Thus, sharing the prompt across a plurality of devices in communication with the information handling device may include providing an entire prompt to each of the plurality of devices, providing a portion of the prompt to each of the plurality of devices, providing an amount of the prompt to each of the plurality of devices based upon an identified component of the device, and/or the like.

The response generation system may utilize a natural language processing (NLP) technique to assist with sharing the prompt. Parsing a received prompt at the response generation system by use of an NLP technique may be performed based upon identifying that one or more of the devices can only process a portion of the prompt or based upon the system identifying that only a portion of the prompt needs to be processed by a connected device. Additionally, and/or alternatively, information present within a knowledge graph of a device may indicated how much of a prompt, either the entire prompt and/or one or more portions, that may be performed by a connected device. In providing a portion of the prompt, the system may take a specific portion of the prompt or may generate a portion of the prompt, for example, through generating a condensed version of the prompt, generating a summarized version of the prompt, generating an abbreviated version of the prompt, and/or the like. Determining how much of a prompt that may be shared may result in parsing the prompt based upon a topic present within a knowledge graph of a device, an importance of terms, keywords, and/or the like, present in the prompt. For example, if the received prompt is “retrieve all documents associated with client A and order the documents based upon their mail date,” the response generation system may determine that keywords present in the prompt are, “documents,” “client A,” “mail date.” Then, for example, the response generation system may determine a device comprising a knowledge graph associated with a user's work which would have access to the documents associated with client A, provide the keywords to the device, and the device may then retrieve the documents and provide them back to a user based on the mail date.

An artificial intelligence (AI) model, for example, a large language model (LLM), a language model, and/or the like, present and/or accessible by each of the plurality of devices in communication may ultimately determine a prompt size that may be accepted and processed by the device. The AI model of the device may then assist with producing a response. Additionally, and/or alternatively, the response generation system may utilize a cross-device optimization method that may identify shards, and/or topics, specific to an AI model of each device. As a continuation of the example included above, when a prompt associated with work is identified by the response generation system, an AI model associated with a device in communication with the information handling device comprising a knowledge graph may receive the shared prompt because a shard of the AI model of the device is specific to work related prompts. In other words, all prompts that are associated with work topics may be shared with the AI model of a device utilized for work. The device(s) including a knowledge graph describing work-related topics are the devices receiving the prompt. Additionally, and/or alternatively, for example, a prompt that is directed to family topics (e.g., schedule, kids, bills, etc.) may be associated with a shard of an AI model different than the AI model that includes the shard directed to work topics. Therefore, the response generation system may track shards present within a prompt and associate the prompt with the identified shard, and thereafter, provide the prompt to the device that can access the AI model associated with the shard. Directing a prompt to a specific device associated with the shard of an AI model may reduce response times and increase efficiency of the system.

Additionally, and/or alternatively, in the system, a device associated with an AI model may further include a knowledge graph specific to the device. A knowledge graph may track and store user data while the device is in use. For example, a smartphone which may always be with a user (e.g., in their pocket, bag, etc.) may store location/time relevant data while a user goes about their day, whereas, a laptop that is not always with a user and/or in use will not be able to track and store the same type of location/time relevant data. A knowledge graph specific to a device that is utilized by a user may track data while the device is in operation. Therefore, for example, when using a laptop specifically for work related topics, the knowledge graph of the laptop may be specific to work related tasks. In combination with the recognition of shards, and/or topics, of the prompt, as mentioned previously, and/or performed independently, the knowledge graph of a device may assist with determining which device(s), and more specifically which AI model associated with a device, may be best suited to respond to a prompt.

The knowledge graph, and/or a relative portion of the knowledge graph, associated with a device may also be shared along with the prompt across a plurality of devices in communication with the information handling device. The response generation system may determine if an entire knowledge graph associated with a device, a portion of the knowledge graph, or none of the knowledge graph may be shared with one or more of the devices in communication with the information handling device. Similar to the restrictions associated with providing a prompt in its entirety and/or providing a portion of the prompt, the response generation system may determine if a device in communication with the information handling device has an ability to utilize a determined amount of data associated with the prompt. In other words, a device that may not have the capability to utilize or receive knowledge graph information along with the prompt may receive an abbreviated form of and/or none of the knowledge graph data at the device.

After sharing a prompt across a plurality of devices in communication with the information handling device, the system may determine if a response to the prompt can be determined by an artificial intelligence model present on at least one of the plurality of devices. An artificial intelligence model may be the large language model, language model, or other AI model associated with each device in communication with the information handling device. Thus, when determining if a response can be produced at 303, at least one AI model of a device in communication with the information handling device must be present. When it is determined that an AI model associated with a device in communication with the information handling device cannot produce a response to a prompt, the system may not provide a response to the prompt at 304.

Additionally, and/or alternatively, when it is determined that a response cannot be provided by the artificial intelligence model at 304, the response generation system may request more information from a user in an attempt to produce a response. Additionally, and/or alternatively, in the system, when it is determined that a response cannot be provided by the artificial intelligence model at 304, the response generation system may provide a standard response generated by the information handling device or a response only generated by the information handling device. For example, a standard response may include short response (e.g., yes or no, true or false, etc.) and/or may perform a standard task (e.g., opening an associated application on the information handling device, etc.). When it is determined that a response cannot be produced by use of an artificial intelligence model of another connected device, the response generation system may be limited in its ability to respond to the prompt.

When it is determined, at 303, that a response to a prompt can be produced by an artificial intelligence model present on at least one of a plurality of devices in communication with the information handling device, the system may then provide a response to the user at 305. When determining a response to a prompt by use of an artificial intelligence model, the response generation system may take into account limitations of devices in communication, as mentioned previously, and a level of efficiency for outputting a response. The response generation system may utilize one or more determination techniques in order to produce the response, and ensure that the response is provided in the most efficient manner. For example, if one determination technique will negatively influence a turnaround time for response (e.g., take an excessive amount of time), then the response generation system may elect to use a different technique in the name of efficiency.

When determining a response to a prompt, an artificial intelligence model, and/or the large language model associated with each device in communication, may be weighed by the response generation system. The response generation system may identify if the prompt may be provided to each device in communication with the information handling device, may identify if the prompt should be provided to a select portion of the devices in communication with the information handling device, may identify if the prompt may be provided to a specific device in communication with the information handling device, may identify if a response to the prompt may be produced at the information handling device that received the prompt and therefore does not require to be shared across the plurality of devices, and/or the like. It is important to note that though a single response determination technique may be utilized to produce a response to prompt, this is intended as a non-limiting example. The response generation system may utilize a combination of response determination techniques in order to produce and, thereafter, provide the response to the user.

The response generation system may determine that only the prompt received at the information handling device may be shared across a plurality of devices in communication with the information handling. In other words, a knowledge graph or portion thereof, an AI model shard, and/or the like, may not be shared across the devices. Utilizing such a response determination technique may result in each device utilizing an AI model specific to the device and a knowledge graph specific to the device, which may assist in identifying the best response. The response generation system may provide the prompt to all devices in communication in an attempt to produce a response at each device. Then, the response generation system may determine if an acceptable response is produced by an individual device and/or in combination of devices.

Providing the prompt to each device in communication may require each device to utilize the information accessible by their associated AI model and presented within their associated knowledge graph. In some instances, a response may be fully developed based upon the AI model and knowledge graph for an individual device. Additionally, and/or alternatively, responses produced by multiple devices may be combined in order to produce a response that thoroughly responds to the prompt received. Combining the responses may include aggregating the responses into a single response, providing each of the responses as separate responses, utilizing portions of the responses, and/or the like.

Additionally, and/or alternatively, the response generation system may determine that a prompt received at an information handling device and relevant knowledge graph information present on the information handling device may be shared to the devices in communication with the information handling device. As mentioned previously, sharing information across a plurality of devices may include sharing information to all devices in communication, and/or sharing information to a determined portion of the devices in communication. The response generation system may determine a portion of devices may receive the shared information based upon shards of a LLM and the knowledge graph present on a device. Then, in the system, when it is determined that a relevant portion of the knowledge graph of the information handling device is similar to a shard of the LLM and the knowledge graph present on at least one of a plurality of devices in communication, the received prompt and the relevant portions of the knowledge graph of the information handling device may be shared to the at least one device in communication.

Recognition of knowledge graph similarities may assist in efficiently producing a response to a prompt. Rather than relying on devices that may not be knowledgeable about a topic, and/or shard, identifying similarities between knowledge graphs may provide a response generation system with a foundational understanding of a prompt, and therefore, produce an accurate response, and/or partial response, in view of the already present knowledge graph topics at a device. Then, the response generation system may determine if a response to a prompt provided by an individual device and/or in combination with at least two devices will supply the most thorough response to a prompt. Therefore, a response determination technique may create or determine a response based upon sharing a prompt along with a relevant portion of a knowledge graph of the information handling device to at least one device in communication that comprises knowledge graph similarities.

Additionally, and/or alternatively, the response generation system may determine that a prompt received at an information handling device and associated relevant knowledge graph material may be shared across all devices in communication with the information handling device regardless of knowledge graph similarities. Sharing a prompt and relevant knowledge graph material to all devices in communication may permit each AI model associated with a device to produce a response. Such a response determination technique may then weigh each response produced at each device in communication with the information handling device in an attempt to produce the most thorough and accurate response for the prompt. For example, a device with a high level of similarity between the relevant knowledge graph portions may provide a more detailed response, whereas a device with a low level of similarity between relevant knowledge graph portions may provide a more common, and/or traditional, response. Thus, the more detailed response may be weighted higher than the less detailed response.

The response generation system may collect all responses provided by each device, and from a plurality of responses, produce the most thorough and accurate response to the received prompt. Additionally, and/or alternatively, by sharing the relevant knowledge graphs portions to each device in combination, the knowledge graphs of each device may be trained and/or expanded by simply being introduced to unknown knowledge graph portions. Then, when future prompts are received, a device that may not previously include knowledge graph portions directed towards a shard of an LLM, and/or topic, may now individually produce a more detailed response. Therefore, a response determination technique may determine a response based upon a response produced by each device in communication with the information handling device, and may further train a device by introducing knowledge graph shards to a plurality of devices that may have no previous knowledge of a topic.

The response generation system may utilize at least one of the outlined response determination techniques when attempting to produce a response to a received prompt. As mentioned previously, a response determination technique may be utilized by an individual device and/or a plurality of devices, and the response generation system may determine if a response from an individual device and/or a combination of responses from the devices in communication will provide the most accurate, most thorough response to the prompt received. Then, subsequent to determining a response to the prompt, the response generation system at an information handling device may provide the response to the user at 305. Providing the response may be include utilizing one of a plurality of methods. For example, a response may be provided audibly and/or visually (e.g., on a display of the information handling device) by the system. Additionally, and/or alternatively, providing a response may include an information handling device performing an action present within the prompt received by the information handling device. In other words, providing a response may include performing an action associated with the prompt, whether that is performing some task, providing responsive output to the user, providing instructions to another device, and/or the like.

The following paragraphs referencing the remaining figure illustrates the steps taken by a response generation system associated with an information handling device and in communication with a plurality of devices each associated with a large language model and comprising independent knowledge graphs. This illustration and the descriptions are intended to be non-limiting examples, and are provided in order to assist with understating the system and methods described above. Further, the response generation system may be performed utilizing methods not described in these figures.

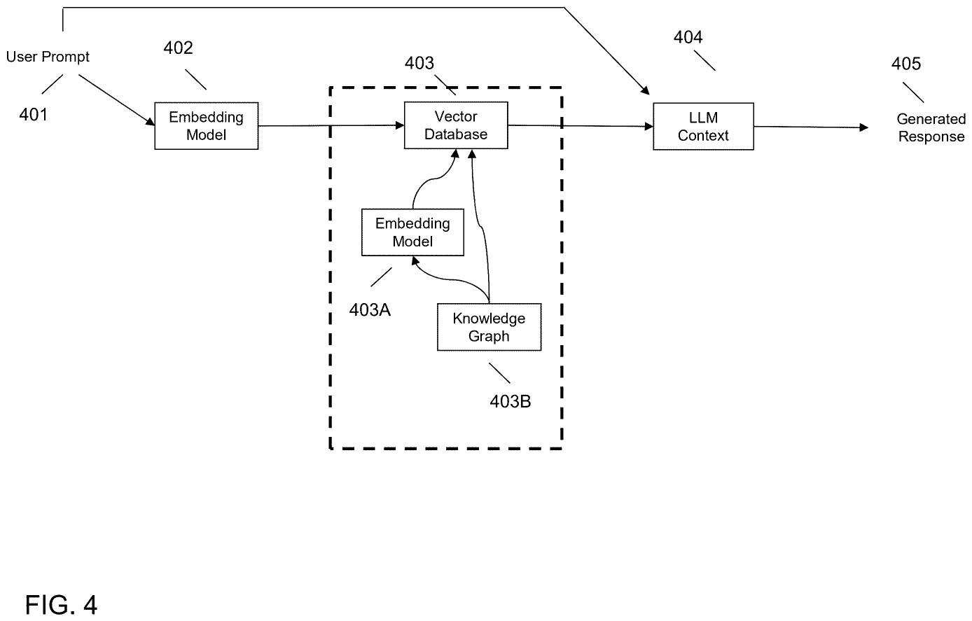

FIG. 4. provides an example illustration of a response generation system and the steps taken in order to generate a response to a received prompt by use of a plurality of devices in communication, with each device being associated with an independent large language model and knowledge graph. At 401, a system may receive a user prompt at an information handling device. The user prompt may be maintained at the information handling device that received the prompt at this step, or may be shared across a plurality of devices in communication with the information handling device. This is dependent on the response determination technique utilized by the system. The arrow directed towards LLM context 404 describes the sharing of the prompt across all devices upon receipt of the prompt at an information handling device. Then, after receipt of the user prompt, the prompt may be moved into embedding model 402. This may be a traditional embedding model that may utilize a method for comprehending what is present within a prompt, for example, a response-type, actions present within a prompt, and/or the like. An embedding model utilized may be based upon an information handling-type that the embedded model is present within/accessed by and/or components available to the information handling device, for example, processing power, storage and/or LLM access, and/or the like. In the system, the embedding model may be a lightweight embedding model, for example, Word2Vec. Techniques utilized in a lightweight embedded model may produce high-quality and accurate embeddings without the need of excessive computational resources. Additionally, and/or alternatively, in the system, the embedding model may be a computationally expensive embedding model, for example, BERT (bidirectional encoder representations and transformers). Based upon an embedding present at a device receiving the user prompt 401, the system may utilize the traditional embedding model 402.

The user prompt 401 may then move through the embedding model 402 and into a vector database 403. The vector database 403 identifies portions of the prompt and additional device specific components that may assist with potentially generating a response. As can be seen in FIG. 4, vector database 403 communicates with embedding model 403A and knowledge graph 403B. Embedding model 403A is the same as embedding model 402 in that they both utilize the same embedding technique. Rather than attempting to utilize different embedding models that may cause disruption in a response generation system, continuity across embedding models 402/403A permits a smooth and thorough understanding of what is present within the prompt. Knowledge graph 403B is a previously computed knowledge graph and is not updated and/or trained in response to the user prompt. Knowledge graphs may be influenced by a prompt after utilization, but will likely not be updated until after the completion of the generation of a response. Vector database 403 may collect all relevant portions of the user prompt that has moved through embedding model 403A and associated, previously established knowledge graph 403B shards. For example, embedding model 403A may provide an abbreviated version of the prompt, and knowledge graph 403B may provide an indication of similar shards between devices in communication with the information handling device to vector database 403.

After moving through the vector database 403 and based upon a response determination technique in use by the response generation system, the prompt and associated devices identified in the vector database 403 will undergo LLM context 404 that may determine a response, and/or a portion of a response, to be supplied back to the user. As mentioned previously, a response may come from a LLM of an individual device in communication with the information handling device, and/or a response may be a combination of responses, or portions of a response, identified and thereafter combined by the LLM context 404. The LLM context 404 will produce the final response and move to the generated response 405 where the response will be provided back to a user. Therefore, FIG. 4 describes a method of generating a response to a prompt by use of artificial intelligence model that weighs knowledge graph shards and a large language model of at least one device in communication with an information handling device.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, a prompt from a user;
sharing, utilizing a response generation system, the prompt across a plurality of devices in communication with the information handling device;
determining, from at least one of the plurality of devices and utilizing an artificial intelligence model of the at least one of the plurality of devices, a response to the prompt; and
providing, at the information handling device, the response to the user.

2. The method of claim 1, wherein the receiving the prompt comprises receiving user input at the information handling device.

3. The method of claim 1, wherein the receiving the prompt comprises receiving the prompt at a user interface associated with the artificial intelligence model of the information handling device.

4. The method of claim 1, wherein the providing the response comprises aggregating responses received from more than one of the plurality of devices and the information handling device.

5. The method of claim 1, wherein the artificial intelligence model comprises a large language model; and
wherein each of the at least one of the plurality of devices and the information handling device employ a unique instance of the large language model.

6. The method of claim 1, wherein the determining comprises utilizing a knowledge graph specific to each of the plurality of devices in communication with the information handling device;
wherein the utilizing the knowledge graph comprises performing a search of the knowledge graph and generating a response based upon the search utilizing the artificial intelligence model of a given of the at least one of the plurality of devices.

7. The method of claim 1, wherein the determining comprises identifying a portion of a knowledge graph associated with the prompt and sharing the portion of the knowledge graph with each of the plurality of devices and the information handling device.

8. The method of claim 7, wherein the determining comprises producing, utilizing the portion of the knowledge graph at the artificial intelligence model of each of the plurality of devices and the information handling device, the response.

9. The method of claim 1, wherein the determining the response comprises producing the response by providing responses produced by the plurality of devices and the information handling device to the artificial intelligence model of a given of the plurality of devices.

10. The method of claim 1, wherein the providing the response comprises providing a response generated by each of the information handling device and the plurality of devices to the user at the information handling device.

11. A system, the system comprising:
a processor;
a memory device that stores instructions that, when executed by the processor, causes the system to:
receive, at an information handling device, a prompt from a user;
share, utilizing a response generation system, the received prompt across a plurality of devices in communication with the information handling device;
determine, from at least one of the plurality of devices and utilizing an artificial intelligence model of the at least one of the plurality of devices, a response to the prompt; and
provide, at the information handling device, the response to the user.

12. The system of claim 11, wherein the receiving the prompt comprises receiving user input at the information handling device.

13. The system of claim 11, wherein the receiving the prompt comprises receiving the prompt at a user interface associated with the artificial intelligence model of the information handling device.

14. The system of claim 11, wherein the providing the response comprises aggregating responses received from more than one of the plurality of devices and the information handling device.

15. The system of claim 11, wherein the artificial intelligence model comprises a large language model; and
wherein each of the at least one of the plurality of devices and the information handling device employ a unique instance of the large language model.

16. The system of claim 11, wherein the determining comprising utilizing a knowledge graph specific to each of the plurality of devices in communication with the information handling device;
wherein the utilizing the knowledge graph comprises performing a search of the knowledge graph and generating a response based upon the search utilizing the artificial intelligence model of a given of the at least one of the plurality of devices.

17. The system of claim 11, wherein the determining comprises identifying a portion of a knowledge graph associated with the prompt and sharing the portion of the knowledge graph with each of the plurality of devices and the information handling device.

18. The system of claim 17, wherein the determining comprises producing, utilizing the portion of the knowledge graph at the artificial intelligence model of each of the plurality of devices and the information handling device, the response.

19. The system of claim 18, wherein the determining the response comprises producing the response by providing responses produced by the plurality of devices and the information handling device to the artificial intelligence model of a given of the plurality of devices.

20. A product, the product comprising:
a computer-readable storage device that stores code that, when executed by a processor, causes the product to:
receive, at an information handling device, a prompt from a user;
share, utilizing a response generation system, the prompt across a plurality of devices in communication with the information handling device;
determine, from at least one of the plurality of devices and utilizing an artificial intelligence model of the at least one of the plurality of devices, a response to the prompt; and
provide, at the information handling device, the response to the user.
